(19) United States
(12) Patent Application Publication
(10) Pub. No.: US 2010/0324768 A1
(43) Pub. Date: Dec. 23, 2010

(54) Method for Coupling an Electric Traction Machine to a Hybrid Vehicle and Hybrid Vehicle for Implementing Said Method

(75) Inventors: Sebastien Besnard, Sceaux (FR); Nicolas Robart, Issy Les Moulineaux (FR)

Correspondence Address: Polster, Lieder, Woodruff & Lucchesi, L.C., 12412 Powerscourt Dr. Suite 200, St. Louis, MO, 63131-3615, US

(73) Assignee: PEUGEOT CITROEN AUTOMOBILES SA, Velizy Villacoublay (FR)

(21) Appl. No.: 12/918,274

(22) PCT Filed: Feb. 24, 2009
(86) PCT No.: PCT/FR09/50289

§ 371 Date: Aug. 18, 2010

(30) Foreign Application Priority Data
Feb. 26, 2008 (FR) 0851188

(51) Int. Cl. G06F 19/00; B60W 20/00

(52) U.S. Cl. 701/22; 180/65.21

(57) ABSTRACT

The invention relates to a method for controlling a hybrid vehicle that comprises a traction chain with a propulsion unit (10) including a thermal engine (18) coupled to the vehicle wheels (14, 16) via a gearbox (22), an electric machine ME (40) that can be configured either as an electric motor for providing a traction torque to the vehicle or as a generator for supplying an electric current to an electric-energy storage means (50) via an electric network (52) of the vehicle, a coupling device (42) positioned between the electric machine and a driving shaft (48) coupled to the vehicle wheels (34, 36), and comprising a control input Ec so as to be switched either into a so-called coupling position providing a mechanical coupling between the electric machine (40) and the driving shaft (48), or into an uncoupling position interrupting the mechanical coupling between said electric machine and the driving shaft, at least one sensor (64, 66) supplying a value of a parameter (Vt, Dc) characteristic of the vehicle movement, and a vehicle control device (60). The coupling device (42) is controlled by the control device (60) for coupling the electric machine (40) to the driving shaft (48) when the value of the parameter characteristic of the vehicle movement exceeds a predetermined threshold (Vts, Des).

### CROSS-REFERENCE TO RELATED APPLICATIONS

The present application is the US national stage under 35 U.S.C. §371 of International Application No. PCT/FR2009/050289 which claims the priority of French application 0851188 filed on Feb. 26, 2008.

### BACKGROUND

The invention involves vehicles of the type including a traction drive with an engine transmission unit (or ETU) with a thermal engine coupled to the front drive of the vehicle through a transmission and an electric machine intended to be coupled to the rear drive of the vehicle.

The invention concerns more specifically hybrid vehicles having two distinct energy reservoirs. It is considered that each of the reservoirs constitutes an energy source transmitted to the wheels of the vehicle to cause it to advance and that the power link to one of the energy reservoirs is reversible. The energy contained in the reversible reservoir can be used to accelerate the vehicle. The kinetic energy of the vehicle, at the time of a deceleration, can be used in turn to replenish this reservoir.

Usually in a hybrid vehicle, a first reservoir contains a fuel, for example gasoline, to operate the thermal engine of the engine transmission unit. The second reversible reservoir is an electric battery.

In the hybrid state-of-the-art vehicles, the electric machine is coupled to the wheels of the vehicle according to different techniques and by application of various coupling strategies often linked to an optimization of the operating points of the electric machine and thermal engine of the hybrid vehicle.

For example, in some coupling strategies, the electric machine provides supplementary torque to the wheels of the vehicle in order to optimize the fuel consumption of the thermal engine, or when insufficient torque is supplied by the thermal engine.

In other strategies the electric machine is coupled to the vehicle's wheels to absorb excess torque supplied by the thermal engine and to transform this excess torque into electrical energy feeding the battery. The electric machine can also be used to propel the vehicle when the thermal engine is stopped and uncoupled from the front wheels.

In all these cases, an electric machine coupled to the wheels of the vehicle in motion translates into a supplementary consumption of fuel because the torque losses caused by the drive in rotation of the electric machine with its coupling device to the vehicle's wheels.

### BRIEF SUMMARY

In order to mitigate the drawbacks of the state-of-the-art hybrid vehicles, the invention proposes a hybrid vehicle control method including a traction drive with an engine transmission unit having a thermal engine coupled to the wheels of the vehicle through a transmission, an electric machine capable to be configured, either as an electric motor to supply a traction torque to the vehicle, or as a generator to supply an electric current to an electric energy storage by means of an electrical network of the vehicle, a coupling device interposed between the electric machine and a drive shaft coupled to the wheels of the vehicle and which includes a control input Ec to be placed either in a coupling position ensuring a mechanical coupling between the electric machine and the drive shaft, or in a decoupling position interrupting the mechanical coupling between the aforesaid electric machine and the drive shaft, at least one sensor supplying the value of a parameter (Vt, Dc) characteristic of the vehicle displacement or motion, a control device of the vehicle,

characterized in that the coupling device is controlled by the control device to couple the electric machine to the drive shaft when the value of the characteristic displacement parameter of the vehicle exceeds a predetermined threshold (Vts, Dcs).

Advantageously, the parameter is the speed Vt of the vehicle, and the coupling device is controlled by coupling the electric machine to the drive shaft when the vehicle's speed Vt is below a predetermined threshold speed of Vts.

In one embodiment of the method, the parameter is the vehicle's deceleration Dc, and the coupling device is controlled by coupling the electric machine to the drive shaft when the deceleration Dc of the vehicle is greater than a predetermined deceleration threshold Dcs.

In another embodiment, the coupling between the electric machine and the drive shaft, consists first of all in synchronizing the electric machine with the drive shaft and then coupling them mechanically.

In another embodiment, when the deceleration level Dc of the vehicle is greater than the predetermined threshold Dcs of deceleration, the method includes a configuration phase of the electric machine as a generator followed by a coupling phase of the electric machine with the drive shaft by the coupling device to supply an electric current by means of electric energy storage.

In another embodiment, the value of the deceleration Dc is calculated from the variation of the vehicle's speed Vt.

The invention also concerns a control device for the implementation of the control method of a hybrid vehicle including a traction drive with an engine transmission unit having a thermal engine coupled to the wheels of the vehicle through a transmission, an electric machine which may be configured, either as electric motor to supply a traction torque to the vehicle, or as generator to supply an electric current to a means of electric energy storage via an electrical network of the vehicle, a coupling device interposed between the electric machine and a drive shaft coupled to the wheels of the vehicle and including a control input Ec to be placed either in the coupling position ensuring a mechanical coupling between the electric machine and the drive shaft, or in a decoupling position interrupting the mechanical coupling between the aforesaid electric machine and the drive shaft, at least one sensor supplying the value of a parameter (Vt, Dc) characteristic of the vehicle displacement,

characterized in that it includes at least one control input receives the value of the parameter (Vt, Dc) supplied by the sensor and one control output driving the control input of the coupling device, the control device is configured to place the coupling device in the coupling position when the value of the parameter (Vt, Dc) crosses a predetermined threshold (Vts, Dcs).

Advantageously, the sensor is a speed sensor of the vehicle.

In one embodiment of the control device, the sensor is a deceleration sensor of the vehicle.

The invention also concerns a hybrid vehicle including the control device according to the invention.

One main goal of the invention is to propose a coupling strategy of the electric machines to the wheels of a hybrid vehicle so as to minimize the losses caused by the drive of its machines by the thermal engine of the vehicle.

Another goal is to propose a hybrid vehicle structure implementing the coupling strategy according to the invention.

### BRIEF DESCRIPTION OF THE DRAWINGS

The invention will be better understood by a description of the method according to the invention and an example of hybrid vehicle architecture for implementing the method in reference to the indexed figures in which:

FIG. 1 shows a hybrid vehicle for implementing the method according to the invention and;

FIG. 2, represents an organizational chart showing the main stages of the method according to the invention.

### DETAILED DESCRIPTION

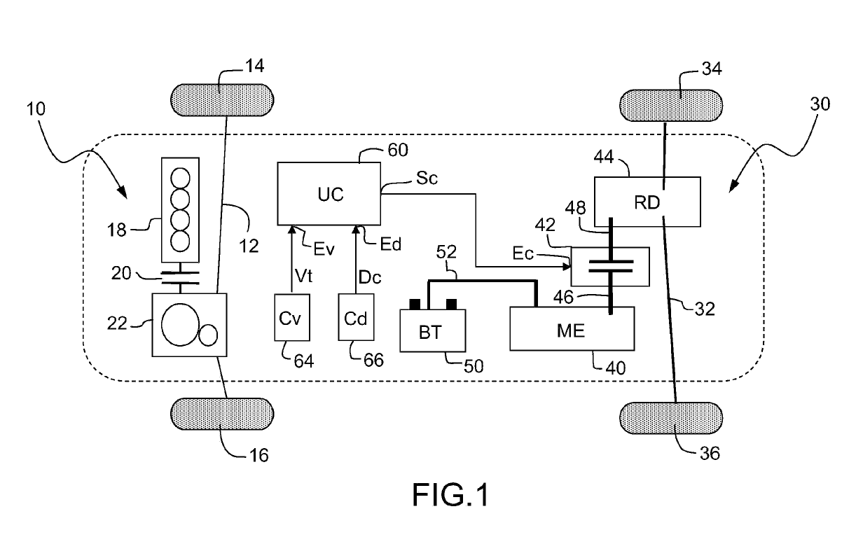

The vehicle of FIG. 1 includes, in the front of the vehicle, a thermal traction chain 10 having a front train 12 and two front wheels 14, 16.

The front wheels are driven in rotation by the torque provided by a thermal engine 18 through a clutch 20 and a transmission 22. The rear of the vehicle includes an electric traction chain 30 having a rear train 32 and two rear wheels 34, 36.

The vehicle of FIG. 1 includes, in addition, an electric machine ME 40, dimensioned to be able to propel the vehicle, and which is intended to be coupled to the rear train 32 of the vehicle via a coupling device 42 and a reduction gear 44.

The electric machine ME includes a rotor shaft 46 intended to be coupled mechanically to a drive shaft 48 of the reduction gear. The reduction gear 44 permits adapting the rotation speed of the rotor shaft 46 of the electric machine 40 to a lower rotation speed of the rear train 32 of the vehicle.

The coupling device 42, inserted between the rotor shaft 46 of the electric machine and the drive shaft 48 of the reduction gear 44 includes a control input Ec to be placed, either in a coupling position, ensuring transmission of a torque between the rotor shaft 46 of the electric machine and the drive shaft 48 of the reduction gear 44, or in a decoupling position, interrupting the transmission of a torque between two shafts 46, 48.

The electric machine 40 may be configured either as an electric motor, for example when hybrid vehicle is in a purely electric propulsion configuration, or as an electric generator, for example at the time of kinetic energy recovery of the vehicle. For this purpose, the vehicle includes a means of electric energy storage 50 coupled to the electric machine by an electrical network 52 of the vehicle.

The electric energy storage means 50 is typically a battery BT 50, or a pack of batteries constituted by a plurality of battery cells.

In electric propulsion configuration, the battery BT 50 provides a supply of current via the electrical network 52 to the electric machine ME. In the kinetic energy recovery configuration of the vehicle, the electric machine charges the battery via the aforesaid electrical network.

The hybrid vehicle according to the invention includes the usual control elements of acceleration and braking (not represented on the figure) controlled by the driver, such as an accelerator pedal, controlling the torque delivered by the engine transmission unit (or ETU) and a brake pedal controlling the braking of the vehicle.

The architecture of the hybrid vehicle represented in FIG. 1, according to the invention, further comprises a means of control, for example a central processing unit UC 60 ensuring the control of the thermal traction chain 10, the electric traction chain 30 and the coupling device 42 to respond to the different strategies for controlling the vehicle according to the main features of the invention.

For this purpose, the central processing unit UC 60 includes an output Sc connected to the control input Ec of the coupling device and receiving two inputs Ev, Ed respectively, the one Ev, a vehicle speed information Vt at the output of a speed sensor Cv 64 and, the other Ed, a vehicle deceleration information Dc at the output of a vehicle deceleration sensor 66.

The speed Vt and the deceleration Dc are the characteristic parameters of the vehicle displacement where the value properly results from the displacement of the case or the cabin of the vehicle.

In a more economic embodiment the vehicle includes a single speed sensor Vt, and the deceleration value Dc can be calculated from the speed variation of the vehicle.

Hereunder the control method of the hybrid vehicle is described according to the invention that is essentially a coupling method of the electric machine 40 on the rear train 32 of the vehicle.

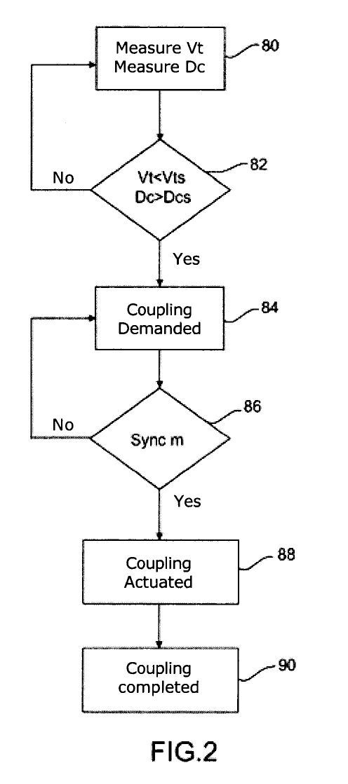

FIG. 2 represents an flow chart showing the main stages of the method according to the invention.

The vehicle's speed threshold Vts and deceleration threshold Dcs are pre-established.

By assumption, in an initial displacement condition of the vehicle, the thresholds of speed Vts and deceleration Dts are not exceeded and the central processing unit UC 60 places the coupling device 40 in the decoupling state, the rotor shaft 46 of the electric machine 40 is decoupled from the drive shaft of the reduction gear 44 and, therefore, from the rear train 30 of the vehicle.

First Stage 80:
continuous measurement of the speed Vt and deceleration Dc parameters of the vehicle;

Second Stage 82:
comparison 82 of the vehicle speed Vt to the predetermined speed threshold Vts and the deceleration Dt of the vehicle to the predetermined deceleration threshold Dts. If the vehicle speed Vt is less than the threshold Vts or if the vehicle deceleration Dc is greater than the threshold Dts (Yes), the central processing unit UC provides a coupling request 84 to the coupling device 40; if the predetermined thresholds are not exceeded (No) the coupling device 42 is maintained in its initial decoupled state;

Third Stage:

If the central processing unit UC 60 provides a coupling request (Yes):
synchronization of the electric machine (sync m). The coupling request causes, before the coupling is effective, a verification phase of the synchronization 86 of the electric machine's rotor shaft 46 with the reduction gear's drive shaft 48. If the synchronization is effective (Yes) the coupling device requests (88) the coupling between the rotor shaft and the drive shaft of the reduction gear, if it is not, the coupling device waits for the synchronization to be effective (No);

Fourth Stage:
the synchronization is effective (Yes), the coupling device is activated (88);

Fifth Stage:
the coupling is performed 90, the rotor shaft 46 of the electric machine is coupled mechanically to the drive shaft 48 of the reduction gear.

The method of coupling of the electric machine to the wheels of the vehicle includes the advantage of eliminating some losses due to driving the electric machine by the thermal engine when it is not useful. For example this is the case when the vehicle is traveling at its nominal speed, the thermal engine then functioning with a good energy yield. In this case, when the machine is mechanically decoupled from the wheels and is in the stop position (null regime) and it is desired or required to couple it to the vehicle's wheels, the energy necessary for the synchronization of the electric machine at the time of the coupling with a shaft coupled to the wheels of the vehicle can be recovered during a deceleration phase lasting only one second.

Otherwise, at the time of the vehicle deceleration, if an electric machine is mechanically uncoupled from the vehicle's wheels, the necessary delay to synchronize this machine with a shaft coupled to the wheels is not constraining because the presence of the electric machine is not required to respond to the deceleration request made by the driver (easing off the accelerator or pressing on the brake pedal for example). This delay has been evaluated at less than one second.

The method according to the invention thus permits deciding at what instants therefore it is desired to couple the electric machine to the rear wheels of the vehicle according to the criteria described above.

Thus, as a non restrictive example allowing the illustration of taking a decision, when the vehicle is rolling at a slow pace (below 80 Km/h for example), it is preferable to couple the machine to ensure a purely electric drive or to provide a possible excess torque.

Beyond this speed, the electric machine is generally less useful because there is no longer any pure electric drive and the motor is better positioned to provide the high performance transients.

Otherwise, when a deceleration of the vehicle is detected, whatever the vehicle speed, it is preferable to couple the electric machine to be able to ensure the electric energy recovery.

The threshold of deceleration, beyond which it is decided to couple the electric machine, for example, can be defined in such a way that the energy that will be recovered in one second of deceleration is greater than or equal to the energy required to synchronize the machine.

1. A method of controlling a hybrid vehicle including a traction drive with an engine transmission unit having a thermal engine coupled to the wheels of the vehicle through a transmission, an electric machine which may be configured either as an electric motor to provide a traction torque to the vehicle or as a generator to supply an electric current to a means for storing electric energy via an electrical network of the vehicle, a coupling device interposed between the electric machine and a drive shaft coupled to the wheels of the vehicle including a control input Ec to be placed either in a so-called coupling position ensuring a coupling between the electric machine and the drive shaft, the coupling between the electric machine and the drive shaft comprising first of all of synchronizing the electric machine with the drive shaft then coupling the electric machine with the drive shaft, or in a decoupling position interrupting the coupling between the electric machine and the drive shaft, at least one sensor providing the value of a parameter characteristic of the vehicle displacement, a control device of the vehicle, wherein the parameter is the deceleration Dc of the vehicle, and the coupling device is commanded to couple the electric machine to the drive shaft when the vehicle deceleration Dc is greater than a deceleration threshold Dcs, the threshold Dcs being determined in such a way that the energy that will be recovered during a determined duration of deceleration is greater than or equal to the energy required to synchronize the machine.

2. The method of controlling a hybrid vehicle according to claim 1 wherein the parameter is the vehicle speed Vt, the coupling device being commanded to couple the electric machine to the drive shaft when the vehicle speed Vt is less than a predetermined speed threshold Vts.

3. The method of controlling a hybrid vehicle according to claim 1 wherein, when the level of vehicle deceleration Dc is greater than the predetermined deceleration threshold Dcs, the method includes a configuration phase of the electric machine into a generator consisting of a coupling phase of the electric machine with the drive shaft by the coupling device to provide an electric current by means of electric energy storage.

4. The method of controlling a hybrid vehicle according to claim 1 wherein, the value of the deceleration Dc is calculated from the variation of the vehicle speed Vt.

5. A device for implementing the method of controlling a hybrid vehicle according to claim 1, wherein, the hybrid vehicle including a traction drive with an engine transmission unit having a thermal engine coupled to the wheels of the vehicle through a transmission, an electric machine which may be configured either as an electric motor to supply a traction torque to the vehicle, or as a generator to supply an electric current to a means of electric energy storage via an electrical network of the vehicle, a coupling device interposed between the electric machine and a drive shaft coupled to the wheels of the vehicle and including a control input Ec to be placed either in said coupling position ensuring a mechanical coupling between the electric machine and the drive shaft, or in a decoupling position interrupting the mechanical coupling between the aforesaid electric machine and the drive shaft, at least one sensor supplying the value of a parameter characteristic of the vehicle displacement, wherein, the control device includes at least one control input receiving the value of the parameter supplied by the sensor and one control output (Sc) driving the control input (Ec) of the coupling device, the control device being configured to place the coupling device in the coupling position when the parameter value crosses a predetermined threshold.

6. The control device according to claim 5, wherein the sensor is a vehicle speed sensor (Cv).

7. The control device according to claim 5, wherein the sensor is a vehicle deceleration sensor (Cd).

8. A hybrid vehicle characterized in that it includes a control device according to claim 5.
